(19) United States
(12) Patent Application Publication
(10) Pub. No.: US 2005/0214203 A1
(43) Pub. Date: Sep. 29, 2005

(54) Catalyst-containing reaction accelerator and steam reforming method using hydrocarbon

(76) Inventors: Kenji Essaki, Kawasaki-shi (JP); Masahiro Kato, Naka-gun (JP); Sawako Yoshikawa, Tokyo (JP); Toshihiro Imada, Yokohama-shi (JP)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 11/087,310

(22) Filed: Mar. 23, 2005

(30) Foreign Application Priority Data
Mar. 29, 2004 (JP) 2004-096944

(51) Int. Cl. C01B 3/24; B01J 21/18

(52) U.S. Cl. 423/651; 502/174

(57) ABSTRACT

A catalyst-containing reaction accelerator used in a steam reforming reaction of hydrocarbon comprises a solid catalyst to accelerate the steam reforming reaction, and a composite absorbent which is mixed with the solid catalyst. The composite absorbent has a main absorbent which contains a lithium-containing oxide for absorbing and desorbing carbon dioxide by-produced by the steam reforming reaction, and a molten carbonate holding material which does not react with the main absorbent at a temperature at which the main absorbent absorbs and desorbs carbon dioxide.

### CROSS-REFERENCE TO RELATED APPLICATIONS

This application is based upon and claims the benefit of priority from prior Japanese Patent Application No. 2004-096944, filed Mar. 29, 2004, the entire contents of which are incorporated herein by reference.

### BACKGROUND OF THE INVENTION

1. Field of the Invention

The present invention relates to a catalyst-containing reaction accelerator which is used in a steam reforming reaction for hydrocarbons and has a catalytic function and a function of absorbing and removing carbon dioxide produced as a by-product, and a steam reforming method using hydrocarbon.

2. Description of the Related Art

As is well known, a steam reforming method which causes a hydrocarbon such as methane to react with steam at high temperatures produces hydrogen and by-produces carbon dioxide.

Jpn. Pat. Appln. KOKAI Publication No. 10-152302 discloses a method which, in a reaction apparatus for performing the steam reforming reaction described above, uses an inorganic carbon dioxide absorbent in addition to a solid catalyst which accelerates the reaction. This method can remove carbon dioxide from a high-temperature reaction field at a temperature exceeding 400° C., and efficiently obtain hydrogen as a main product. Hydrogen is thus efficiently produced because carbon dioxide is removed from the reaction field and thereby the chemical equilibrium shifts to the main product production side. Lithium silicate is attracting attention and studied as an absorbent. Lithium silicate can absorb carbon dioxide at high temperatures at which the steam reforming reaction occurs, and has a high absorbing rate. More specifically, lithium silicate reacts with carbon dioxide and changes into a compound containing lithium carbonate and silicon as indicated by
Li₄SiO₄+2CO₂ [symbol] 2Li₂CO₃+SiO₂+Q (1)
Li₄SiO₄+CO₂ [symbol] Li₂CO₃+Li₂SiO₃+Q (2)

In each of formulas (1) and (2), if a rightward reaction occurs, carbon dioxide reacts with and is absorbed by lithium silicate. The rate of this carbon dioxide absorbing reaction is highest at about 600° C. These reactions are exothermic reactions. On the other hand, a steam reforming reaction of methane is an endothermic reaction indicated by formula (3) below. Accordingly, the hydrogen production efficiency can be increased by the presence of lithium silicate in the reaction field. This also makes it possible to compensate for heat required for the production of hydrogen by exothermic heat generated when carbon dioxide is absorbed, thereby efficiently using the thermal energy.
CH₄+2H₂O [symbol] 4H₂+CO₂−Q (3)

As described above, when a solid catalyst and carbon dioxide absorbent are filled in a steam reforming reaction apparatus, a method using the solid catalyst and carbon dioxide absorbent by mixing them is presumably easiest and most efficient.

Also, Jpn. Pat. Appln. KOKAI Publication No. 2002-274809 describes that the heating amount necessary for regeneration is reduced by using a first reactor filled with a mixture of a solid catalyst and carbon dioxide absorbent, and a second reactor arranged at a previous portion of the first reactor and filled only with the solid catalyst.

Unfortunately, when the mixture of the solid catalyst and carbon dioxide absorbent is thus filled, the performance of the solid catalyst deteriorates after a long-term use. That is, a molten carbonate (Li₂CO₃) produced, when the carbon dioxide absorbent such as lithium silicate absorbs carbon dioxide, flows out from the absorbent. Therefore, the molten carbonate fluid reaches the coexisting solid catalyst to cover its surface with the molten carbonate. Since the solid catalyst is a porous material, its pores are closed by covering with the molten carbonate, thereby reducing the specific surface area and deteriorating the catalytic action. At the same time, the reaction component of the carbon dioxide absorbent reduces, and its absorptivity lowers. Especially in a long-term use in which absorption and regeneration are repeated by the carbon dioxide absorbent, the performances of the solid catalyst and absorbent is deteriorated by occurring the movement and outflow of this molten carbonate.

To prevent this performance deterioration, it is effective to separately fill the solid catalyst and carbon dioxide absorbent. For example, Jpn. Pat. Appln. KOKAI Publication No. 10-152302 described above discloses a reaction tube having a double-tube structure including a porous inner tube filled with the solid catalyst and an outer tube filled with the carbon dioxide absorbent. However, when a hydrogen reforming reaction of hydrocarbon is performed in this reaction tube, a portion of the reaction gas produced by the solid catalyst in the inner tube moves through the porous inner tube to the outer tube filled with the carbon dioxide absorbent, but most of the reaction gas flows in the inner tube. Especially when the gas flow amount is large the carbon dioxide absorbing action of the carbon dioxide absorbent filled in the outer tube does not contribute highly. This makes it difficult to achieve the effect of shifting the chemical equilibrium toward the hydrogen production side as indicated by formula (3).

For the reasons as explained above, researchers are seeking a carbon dioxide absorbent by which no molten carbonate flows out from a solid catalyst even if a steam reforming reaction of hydrocarbon is performed using a mixture of the solid catalyst and carbon dioxide absorbent. Jpn. Pat. Appln. KOKAI Publication No. 2001-252557 discloses a carbon dioxide absorbent including a core made of a porous material having fine pores, and an outer shell surrounding the core and made of a porous material having holes larger in diameter than the fine pores of the core. This carbon dioxide absorbent can dispersedly store, in the holes of the outer shell, a molten carbonate produced by the absorption of carbon dioxide, thereby preventing an overflow and uneven distribution of the molten carbonate on the surface of the core. As a consequence, when this carbon dioxide absorbent alone is repetitively used, its performance does not deteriorate.

Unfortunately, when this carbon dioxide absorbent is filled in the holes of the outer shell so as to mix with a solid catalyst, the molten carbonate and the solid catalyst partially come in contact with each other. In this absorbent having the above constitute, it is difficult to prevent deterioration of the solid catalyst after a long-term repetitive use.

### BRIEF SUMMARY OF THE INVENTION

According to an aspect of the present invention, there is provided a catalyst-containing reaction accelerator used in a steam reforming reaction for hydrocarbon, comprising:
a solid catalyst to accelerate the steam reforming reaction; and
a composite absorbent which is mixed with the solid catalyst, and has a main absorbent which contains a lithium-containing oxide for absorbing and desorbing carbon dioxide by-produced by the steam reforming reaction, and a molten carbonate holding material which does not react with the main absorbent at a temperature at which the main absorbent absorbs and desorbs carbon dioxide.

According to another aspect of the present invention, there is provided a steam reforming method using hydrocarbon, comprising:
preparing a reactor filled with a catalyst-containing reaction accelerator comprising (a) a solid catalyst, and (b) a composite absorbent which is mixed with the solid catalyst, and has a main absorbent which contains a lithium-containing oxide for absorbing and desorbing carbon dioxide by-produced by a steam reforming reaction, and a molten carbonate holding material which does not react with the main absorbent at a temperature at which the main absorbent absorbs and desorbs carbon dioxide; and
supplying hydrocarbon and steam into the reactor at a temperature at which the steam reforming reaction is possible.

### BRIEF DESCRIPTION OF THE SEVERAL VIEWS OF THE DRAWING

FIG. 1 is a schematic view showing an embodiment of a composite absorbent forming a catalyst-containing reaction accelerator according to the present invention;

FIG. 2 is a schematic view showing an embodiment of the catalyst-containing reaction accelerator according to the present invention;

FIG. 3 is a schematic view showing a chemical reactor used in the examples; and

FIG. 4 is a graph showing the methane reforming ratio in an operation in which a steam reforming reaction and the regeneration of a composite absorbent (or an absorbent) are repeated by using a catalyst-containing reaction accelerator of each of Examples 1 to 8 and Comparative Example 1.

### DETAILED DESCRIPTION OF THE INVENTION

A catalyst-containing reaction accelerator according to an embodiment will be described in detail below.

This catalyst-containing reaction accelerator contains a solid catalyst to accelerate a steam reforming reaction of hydrocarbon, and a composite absorbent which is mixed with the solid catalyst. The composite absorbent has a main absorbent which contains a lithium-containing oxide for absorbing and removing carbon dioxide by-produced by the steam reforming reaction, and a molten carbonate holding material which does not react with the main absorbent at a temperature at which the main absorbent absorbs and desorbs carbon dioxide.

1) Solid Catalyst

This solid catalyst is not particularly limited as long as it encourages a steam reforming reaction of hydrocarbon. Desirable examples are a nickel-based catalyst obtained by carrying nickel on a carrier made of alumina or silica, and a ruthenium-based catalyst obtained by carrying ruthenium on a carrier made of alumina or silica. Also, an iron-based oxide such as iron oxide or an iron-chromium composite oxide can be mixed in the solid catalyst positioned after a gas flow path of the steam reforming reaction field.

The solid catalyst can be used in various forms. For example, it is preferable to use the solid catalyst in the form of particles having an average particle diameter of 1 to 20 mm.

2) Composite Absorbent

This composite absorbent has the main absorbent which contains the lithium-containing oxide and the molten carbonate holding material, and can be taken various forms. Especially, in the composite absorbent, the main absorbent has a porous structure having a large number of gaps, and the molten carbonate holding material present in at least the gaps or pores of the main absorbent in the form of particles or fibers. The porous main absorbent preferably consists of particles of the lithium-containing oxide. In the composite absorbent, the molten carbonate holding material may also be partially buried in the gaps of the porous main absorbent.

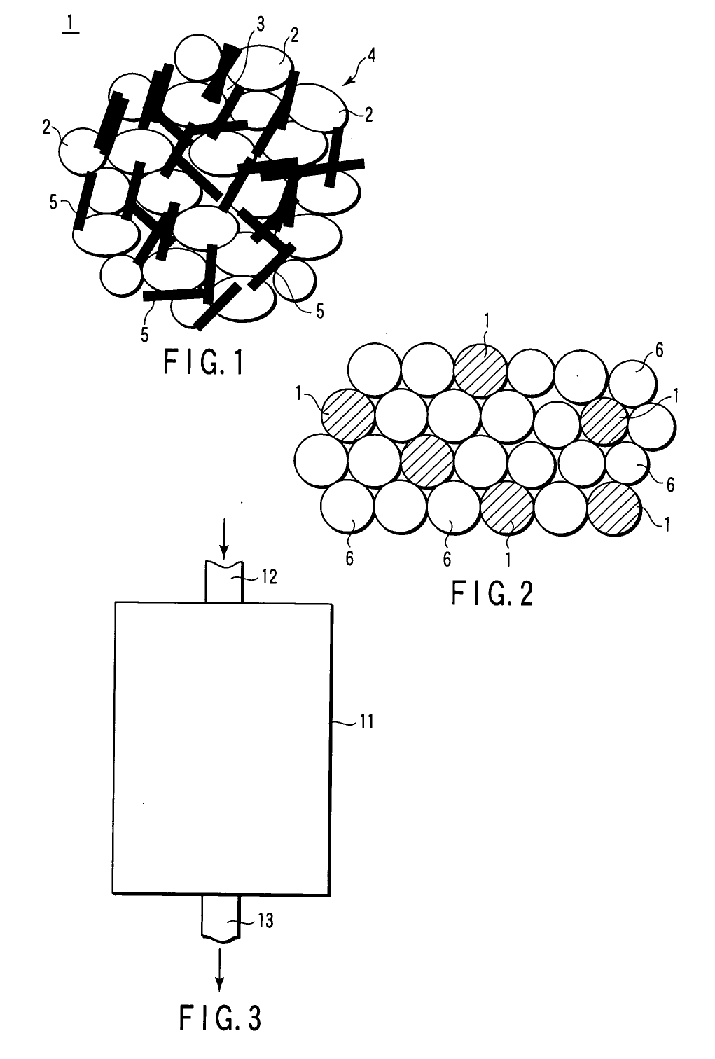

In a practical embodiment, as schematically shown in FIG. 1, a disk-like composite absorbent 1 has a porous main absorbent 4 consisting of lithium-containing oxide particles 2 and having a large number of gaps 3. A fibrous molten carbonate holding material 5 present in the gaps 3 of the porous main absorbent 4.

This composite absorbent having the porous main absorbent improves the carbon dioxide absorbing/desorbing performance, and can be readily handled during operation. In addition, the composite absorbent reduces the pressure loss because a carbon dioxide flow path is ensured.

The porous main absorbent has a porosity of preferably 30% or more, more preferably 35% or more, and most preferably 40 to 60%. If the porosity of the porous main absorbent is less than 30%, a space in which lithium carbonate produced by the absorption of carbon dioxide is present may become insufficient, and this may decrease the carbon dioxide absorptivity.

The composite absorbent has the form of, e.g., granules, a column, a disk, or a honeycomb.

Examples of the lithium-containing oxide contained in the main absorbent are lithium silicate (Li₄SiO₄), lithium zirconate, and lithium ferrite. Lithium silicate is particularly preferable because its carbon dioxide absorbing/desorbing temperature is 400 to 700° C. which is close to the temperature of the steam reforming reaction field.

When the main absorbent is made porous, the particles of the lithium-containing oxide used in the porous main absorbent preferably have an average particle diameter of 50 μm or less. If the average particle diameter of the particles exceeds 50 μm, the volume of the gaps formed by the main absorbent of the porous composite absorbent reduces. This may reduce the space in which lithium carbonate produced by the absorption of carbon dioxide is present, and decrease the carbon dioxide absorptivity. The average particle diameter of the particles of the lithium-containing oxide is more preferably 1 to 40 μm.

The molten carbonate holding material prevents an outflow of a molten carbonate produced when the main absorbent which coexists as the composite absorbent reacts with and absorbs carbon dioxide, and suppresses or prevents this molten carbonate from moving to the solid catalyst which is mixed with the composite absorbent.

The molten carbonate holding material is preferably mixed in the main absorbent within the range of 5 to 30 wt % based on the total amount of the main absorbent and the holding material. If the mixing amount of this molten carbonate holding material is less than 5 wt %, it may become difficult to effectively suppress or prevent an outflow of a molten carbonate produced when the main absorbent reacts with and absorbs carbon dioxide. If the mixing amount of the molten carbonate holding material exceeds 30 wt %, the amount the main absorbent occupies in the composite absorbent relatively reduces, and this may lower the carbon dioxide absorptivity.

The molten carbonate holding material is selected from materials which do not react with the main absorbent at temperatures at which the main absorbent absorbs and desorbs (regenerates) carbon dioxide. Examples of this molten carbonate holding material are lithium-containing oxides, such as lithium titanate, lithium aluminate, and lithium zirconate, different from the lithium-containing oxide used in the main absorbent. Lithium titanate is particularly preferable because when the composite absorbent is made porous, the particle growth of the lithium-containing oxide contained in the main absorbent can be suppressed, so the initial porous structure can be maintained.

The molten carbonate holding material is used in the form of, e.g., particles or fibers. When the main absorbent is made porous, the particulate molten carbonate holding material presented in at least the gaps of the porous main absorbent preferably has an average particle diameter of 0.1 to 10 μm. Likewise, when the main absorbent is made porous, the fibrous molten carbonate holding material presented in at least the gaps of the porous main absorbent preferably has an average diameter of 0.1 to 5 μm and an average length of 1 to 60 μm. In particular, the fibrous molten carbonate holding material can have a molten carbonate holding capability equal to that of the particulate molten carbonate holding material even when the mixing amount in the main absorbent is reduced (e.g., 5 to 20 wt % with respect to the total amount of the main absorbent and the holding material). As a consequence, the amount of molten carbonate holding material in the composite absorbent reduces, so the amount of main absorbent which contributes to the reaction with carbon dioxide can be increased. This further increases the absorptivity of the composite absorbent.

Methods of manufacturing the composite absorbent (the main absorbent; e.g., lithium silicate, and the molten carbonate holding material; e.g., lithium titanate) will be explained below.

(1) A lithium carbonate powder and silicon dioxide powder as material powders of lithium silicate are mixed with particles (or fibers) of lithium titanate as a molten carbonate holding material, and the mixture is synthesized to manufacture a composite absorbent material.

The mixing ratio (Li₂CO₃:SiO₂) of the lithium carbonate powder to the silicon dioxide powder is 2:1 as a molar ratio. The synthesis is preferably performed in an electric oven at a temperature of, e.g., 600 to 1,200° C.

(2) After a powder of a main absorbent is formed by heat treatment of the material powders of lithium silicate described above at a temperature of, e.g., 600 to 1,200° C., particles (or fibers) of lithium titanate are mixed in this main absorbent powder to manufacture a composite absorbent material.

(3) Particles (or fibers) of a compound (titanium oxide or potassium titanate: K₂O.6TiO₂ or K₂O.8TiO₂) which reacts with lithium carbonate to produce particles (or fibers) of lithium titanate are mixed with lithium carbonate. After that, the mixture is mixed in the material powders of lithium silicate described above, and the resultant mixture is synthesized at a temperature of, e.g., 600 to 1,200° C. to manufacture a composite absorbent material.

(4) After a powder of a main absorbent is formed by heat treatment of the material powders of lithium silicate described above at a temperature of 600 to 1,200° C., the mixture of the particles (or fibers) of titanium oxide or potassium titanate and lithium carbonate described above is added to the main absorbent powder to manufacture a composite absorbent material.

In the above methods, during the heating process when absorption and desorption of carbon dioxide are performed for the first time, the titanium oxide or potassium titanate and the lithium carbonate react with each other to produce lithium titanate.

In the manufacture of the composite absorbent materials described in items (1) to (4) above, the carbon dioxide gas absorption rate can be increased by adding an alkali carbonate for the reason explained below. That is, lithium carbonate produced by the absorption of carbon dioxide by lithium silicate as the main absorbent and the added alkali carbonate form eutectic salt. This lowers the melting point of the material, and produces a liquid phase. Consequently, the mobility of lithium increases and raises the carbon dioxide gas absorption rate.

The obtained the composite absorbent material can be pulverized by a pulverizer such as a ball mill, and used as a powdery composite absorbent. It is also possible to granulate this powder to form granules or a mass of a composite absorbent.

Furthermore, the porous composite absorbent having the porous main absorbent described above is obtained by pulverizing the composite absorbent material into a powder, and molding this powder into a columnar, disk-like, or honeycomb block by molding means such as extrusion molding. The porosity of the porous main absorbent in this composite absorbent can be controlled by adjusting primarily the molding pressure.

Note that in the manufacture of the composite absorbent materials described in items (1) and (3), the molding means described above can be applied to the material powders before synthesis.

The mixing ratio of the solid catalyst to the composite absorbent depends on the conditions, in the steam reforming reaction field, such as the amount of main absorbent with respect to the total amount of the solid catalyst and composite absorbent, the supply amount of hydrocarbon, and the temperature. However, the weight ratio of the solid catalyst to the composite absorbent, i.e., the weight ratio of the solid catalyst:composite absorbent, is preferably about 1:1 to 1:15.

In a practical embodiment, the catalyst-containing reaction accelerator is formed by mixing a disk-like composite absorbent 1 and particulate solid catalyst 6 as shown in FIG. 2.

A steam reforming method using hydrocarbon will be described below.

A reactor having a gas inlet and outlet, filled with the catalyst-containing reaction accelerator described above, and having a desired shape is prepared. A gas mixture of hydrocarbons such as methane, ethane, or propane and steam is supplied into this reactor at a temperature at which a steam reforming reaction is possible. This temperature at which a steam reforming reaction is possible is set by heating one or both of the gas mixture and the catalyst-containing reaction accelerator filled in the reactor. The temperature is 500 to 650° C. when hydrocarbon is, e.g., methane.

When the gas mixture of hydrocarbon (e.g., methane) and steam is supplied into the reactor at a temperature of 500 to 650° C., a steam reforming reaction represented by the formula (3) progresses between these methane and steam in the presence of the solid catalyst contained in the catalyst-containing reaction accelerator. As a consequence, hydrogen is produced, and carbon dioxide is by-produced. The by-produced carbon dioxide reacts, in accordance with the formula (1) or (2), with the main absorbent (e.g., lithium silicate) contained in the composite absorbent of the catalyst-containing reaction accelerator placed in this steam reforming reaction field, and is absorbed and removed as lithium carbonate from the reaction field. Since the chemical equilibrium indicated by formula (3) is shifted to the hydrogen production side by thus removing carbon dioxide by-produced in the steam reforming reaction field, the hydrogen production efficiency can be raised.

Lithium carbonate (lithium carbonate melted at the ambient temperature) produced when the main absorbent contained in the composite absorbent absorbs carbon dioxide is held by the molten carbonate holding material contained in the composite absorbent. Accordingly, an outflow of this lithium carbonate is suppressed or prevented.

When the carbon dioxide absorptivity of the composite absorbent contained in the catalyst-containing reaction accelerator which is placed in the steam reforming reaction field lowers, the supply of the gas mixture into the reactor is stopped. After that, the internal temperature of the reactor is raised to a temperature higher than that of the steam reforming reaction, e.g., 550 to 800° C. if the main absorbent contained in the composite absorbent is lithium silicate, thereby causing a reaction from the right to the left in formula (1) or (2) and regenerating the composite absorbent. If the main absorbent contained in the composite absorbent is set in an atmosphere contained carbon dioxide, an operation of the regenerating is preferably carried out at temperature of 720 to 900° C.

By repeating the steam reforming reaction and the regeneration of the composite absorbent (main absorbent) contained in the catalyst-containing reaction accelerator as described above, hydrogen can be efficiently produced from methane and steam.

In the embodiment as described above, the catalyst-containing reaction accelerator is formed by mixing the composite absorbent having the main absorbent containing the lithium-containing oxide and the molten carbonate holding material with the solid catalyst. Therefore, carbon dioxide by-produced in a steam reforming reaction of hydrocarbon is absorbed and removed by the main absorbent of the composite absorbent, so the steam reforming reaction of hydrocarbon such as methane indicated by the formula (3) is shifted to the right. At the same time, a molten carbonate produced in the composite absorbent is kept within by the molten carbonate holding material, so an outflow of the molten carbonate from the composite absorbent can be suppressed or prevented. Accordingly, the molten carbonate does not flow out and mix in the composite absorbent. This makes it possible to protect the surface of the porous solid catalyst, which is mixed with and brought into contact with the composite absorbent, from being covered with the molten carbonate as it flows out.

Consequently, it is possible to prevent a decrease in specific surface area of the solid catalyst, and maintain a predetermined catalytic action. It is also possible to prevent an outflow and reduction of the main absorbent from the composite absorbent, and maintain the carbon dioxide absorptivity of the composite absorbent.

Accordingly, even after a long-term use by which the operation of absorbing and regenerating carbon dioxide is repeated by the composite absorbent which is mixed with the solid catalyst in the field of a steam reforming reaction of hydrocarbon, a good catalytic action of the solid catalyst can be maintained. In addition, the carbon dioxide absorptivity of the composite absorbent itself can be maintained. Therefore, it is possible to provide a catalyst-containing reaction accelerator capable of efficiently producing hydrogen as a main product for long time periods.

In particular, it is desirable that the main absorbent has a porous structure which has a large number of gaps, and the molten carbonate holding material present in at least the gaps of the main absorbent in the form of particles or fibers. That is, when a molten carbonate produced by the absorption of carbon dioxide flows outside through the gaps in the main absorbent, the molten carbonate holding material present in the gaps functions as a dam to effectively suppress or prevent this outflow. Specifically, when fibers are used as this molten carbonate holding material, the outflow of the molten carbonate produced by the absorption of carbon dioxide can be more effectively suppressed or prevented.

Also, in the composite absorbent, the molten carbonate holding material is present in the gaps of the porous main absorbent, and suppresses the growth of the lithium-containing oxide particles forming the main absorbent. This makes it possible to suppress the decrease in porosity of the porous main absorbent, and hence suppress the decrease in porosity of the composite absorbent. As a consequence, the carbon dioxide absorptivity of the composite absorbent can be maintained over a long period of time.

Especially when the molten carbonate holding material is made of lithium titanate, it is possible to more effectively suppress the growth of the lithium-containing oxide particles forming the main absorbent, and maintain the initial porous structure of the composite absorbent. Consequently, the carbon dioxide absorptivity of the composite absorbent can be maintained more stably over long time periods.

Examples of the present invention will be explained below.

### EXAMPLE 1

A silicon dioxide powder having an average particle diameter of 10 μm, a lithium carbonate powder having an average particle diameter of 1 μm, and a potassium carbonate powder having an average particle diameter of 1 μm were so weighed that the molar ratio of silicon dioxide:lithium carbonate:potassium carbonate was 1:2:0.1, thereby obtaining a material powder. Subsequently, 10 wt % of a fibrous lithium titanate powder having an average diameter of 0.5 μm and an average length of 15 μm were added to the material powder. The mixture was milled and mixed by a ball mill. The resultant material powder mixture was heated in a boxy electric oven in the atmosphere at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 5 μm, and the fibrous lithium titanate had an average length of 10 μm. This composite absorbent material powder was filled in a metal mold having an inner diameter of 5 mm, and molded under pressure to form a columnar composite absorbent. This composite absorbent had a diameter of 5 mm and a length of 5 mm. In addition, the composite absorbent consisted of a porous main absorbent consisting of the lithium silicate particles and having a porosity of 50%, and the lithium titanate fibers partially buried in gaps of the porous main absorbent.

Then, the composite absorbent was evenly mixed in alumina particles (a solid catalyst) carrying about 10 wt % of metal nickel and having an average particle diameter of 5 mm, such that the weight ratio of the composite absorbent to the solid catalyst was 1:4, thereby manufacturing a catalyst-containing reaction accelerator.

### EXAMPLE 2

20 wt % of a fibrous lithium titanate powder having an average diameter of 0.5 μm and an average length of 15 μm were added to a material powder containing a silicon dioxide powder, lithium carbonate powder, and potassium carbonate powder similar to those of Example 1. The mixture was milled and mixed by a ball mill. The resultant material powder mixture was heated in a boxy electric oven at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 5 μm, and the fibrous lithium titanate had an average length of 10 μn. This composite absorbent material powder was filled in a metal mold having an inner diameter of 5 mm, and molded under pressure to form a columnar composite absorbent. This composite absorbent had a diameter of 5 mm and a length of 8 mm. In addition, the composite absorbent consisted of a porous main absorbent consisting of the lithium silicate particles and having a porosity of 50%, and the lithium titanate fibers partially buried in gaps of the porous main absorbent.

Then, the composite absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

### EXAMPLE 3

30 wt % of a fibrous lithium titanate powder having an average diameter of 0.5 μm and an average length of 15 μm were added to a material powder containing a silicon dioxide powder, lithium carbonate powder, potassium carbonate powder similar to those of Example 1. The mixture was milled and mixed by a ball mill. The resultant material powder mixture was heated in a boxy electric oven at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 5 μm, and the fibrous lithium titanate had an average length of 10 μm. This composite absorbent material powder was filled in a metal mold having an inner diameter of 5 mm, and molded under pressure to form a columnar composite absorbent. This composite absorbent had a diameter of 5 mm and a length of 8 mm. In addition, the composite absorbent consisted of a porous main absorbent consisting of the lithium silicate particles and having a porosity of 50%, and the lithium titanate fibers partially buried in gaps of the porous main absorbent.

Then, the composite absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

### EXAMPLE 4

20 wt % of a fibrous lithium titanate powder having an average diameter of 0.5 μm and an average length of 15 μm were added to a material powder containing a silicon dioxide powder, lithium carbonate powder, potassium carbonate powder similar to those of Example 1. The mixture was milled and mixed by a ball mill. The resultant material powder mixture was heated in a boxy electric oven at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 3 μm, and the fibrous lithium titanate had an average length of 8 μm. This composite absorbent material powder was filled in a metal mold having an inner diameter of 5 mm, and molded under pressure to form a columnar composite absorbent. This composite absorbent had a diameter of 5 mm and a length of 8 mm. In addition, the composite absorbent consisted of a porous main absorbent consisting of the lithium silicate particles and having a porosity of 50%, and the lithium titanate fibers partially buried in gaps of the porous main absorbent.

Then, the composite absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

### EXAMPLE 5

20 wt % of a fibrous lithium titanate powder having an average diameter of 0.5 μm and an average length of 15 μm were added to a material powder containing a silicon dioxide powder, lithium carbonate powder, potassium carbonate powder similar to those of Example 1. The mixture was milled and mixed by a ball mill. The resultant material powder mixture was heated in a boxy electric oven at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 10 μm, and the fibrous lithium titanate had an average length of 14 μm. This composite absorbent material powder was filled in a metal mold having an inner diameter of 5 mm, and molded under pressure to form a columnar composite absorbent. This composite absorbent had a diameter of 5 mm and a length of 8 mm. In addition, the composite absorbent consisted of a porous main absorbent consisting of the lithium silicate particles and having a porosity of 50%, and the lithium titanate fibers partially buried in gaps of the porous main absorbent.

Then, the composite absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

### EXAMPLE 6

20 wt % of a fibrous lithium titanate powder having an average diameter of 1.0 μm and an average length of 10 μm were added to a material powder containing a silicon dioxide powder, lithium carbonate powder, potassium carbonate powder similar to those of Example 1. The mixture was milled and mixed by a ball mill. The resultant material powder mixture was heated in a boxy electric oven in the atmosphere at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 5 μm, and the fibrous lithium titanate had an average length of 5 μm. This composite absorbent material powder was filled in a metal mold having an inner diameter of 5 mm, and molded under pressure to form a columnar composite absorbent. This composite absorbent had a diameter of 5 mm and a length of 8 mm. In addition, the composite absorbent consisted of a porous main absorbent consisting of the lithium silicate particles and having a porosity of 50%, and the lithium titanate fibers partially buried in gaps of the porous main absorbent.

Then, the composite absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

### EXAMPLE 7

10 wt % of a fibrous lithium titanate powder having an average diameter of 0.5 μm and an average length of 15 μm were added to a material powder containing a silicon dioxide powder, lithium carbonate powder, potassium carbonate powder similar to those of Example 1. The mixture was milled and mixed by a ball mill. The resultant material powder mixture was heated in a boxy electric oven at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 5 μm, and the fibrous lithium titanate had an average length of 10 μm. This composite absorbent material powder was filled in a metal mold having an inner diameter of 5 mm, and molded under pressure to form a columnar composite absorbent. This composite absorbent had a diameter of 5 mm and a length of 8 mm. In addition, the composite absorbent consisted of a porous main absorbent consisting of the lithium silicate particles and having a porosity of 40%, and the lithium titanate fibers partially buried in gaps of the porous main absorbent.

Then, the composite absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

### EXAMPLE 8

10 wt % of a fibrous lithium titanate powder having an average diameter of 0.5 μm and an average length of 15 μm were added to a material powder containing a silicon dioxide powder, lithium carbonate powder, potassium carbonate powder similar to those of Example 1. The mixture was milled and mixed by a ball mill. The resultant material powder mixture was heated in a boxy electric oven at 900° C. for 8 hrs, thereby synthesizing lithium silicate (a composite absorbent material) containing the fibrous lithium titanate. The obtained composite absorbent material was milled by the ball mill such that the lithium silicate had an average particle diameter of 5 μm, and the fibrous lithium titanate had an average length of 10 μm. This composite absorbent material powder was filled in a metal mold having an inner diameter of 5 mm, and molded under pressure to form a columnar composite absorbent. This composite absorbent had a diameter of 5 mm and a length of 8 mm. In addition, the composite absorbent consisted of a porous main absorbent consisting of the lithium silicate particles and having a porosity of 35%, and the lithium titanate fibers partially buried in gaps of the porous main absorbent.

Then, the composite absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

### COMPARATIVE EXAMPLE 1

A material powder containing a silicon dioxide powder, lithium carbonate powder, potassium carbonate powder similar to those of Example 1 was milled and mixed by a ball mill. The resultant material powder mixture was heated in a boxy electric oven at 900° C. for 8 hrs, thereby synthesizing lithium silicate. The obtained lithium silicate was milled by the ball mill such that the average particle diameter was 5 μm. This lithium silicate powder was filled in a metal mold having an inner diameter of 5 mm, and molded under pressure to form a columnar absorbent having a diameter of 5 mm, a length of 8 mm, and a porosity of 50%. Then, the absorbent was evenly mixed in alumina particles (a solid catalyst) carrying about 20 wt % of metal nickel and having an average particle diameter of 5 mm, such that the weight ratio of the composite absorbent to the solid catalyst was 1:4, thereby manufacturing a catalyst-containing reaction accelerator.

The catalyst-containing reaction accelerator obtained by each of Examples 1 to 8 and Comparative Example 1 was filled in a reactor shown in FIG. 3, and a steam reforming reaction of methane was performed to produce hydrogen. A reactor 11 was a cylinder 1.1 m in inner diameter and 1.6 m in height, and had a gas supply pipe 12 in the upper portion and a gas exhaust pipe 13 in the lower portion. Alumina balls having an average diameter of 5 mm were filled in an inner space having a height of 0.1 m from the bottom of this reactor. 750 kg of the catalyst-containing reaction accelerator was filled above the alumina balls, and alumina balls having an average diameter of about 5 mm were filled above the catalyst-containing reaction accelerator to a height of about 0.1 m.

Steam (H₂O) and methane (CH₄) were mixed such that the molar ratio of H₂O/CH₄=4. This gas mixture (source gas) heated to 600° C. was supplied into the reactor 11 from the gas supply pipe 12 of the reactor 11 at a flow rate of 10 m³/min as a standard state flow rate, thereby performing a steam reforming reaction of methane.

Also, when the carbon dioxide absorptivity of the composite absorbent (or the absorbent) of the catalyst-containing reaction accelerator filled in the reactor 11 lowered, carbon dioxide gas preheated to 900° C. was supplied from the gas supply pipe 12 of the reactor 11 at a flow rate of 30 m³/min as a standard state flow rate, thereby regenerating the main absorbent (or the absorbent) of the catalyst-containing reaction accelerator.

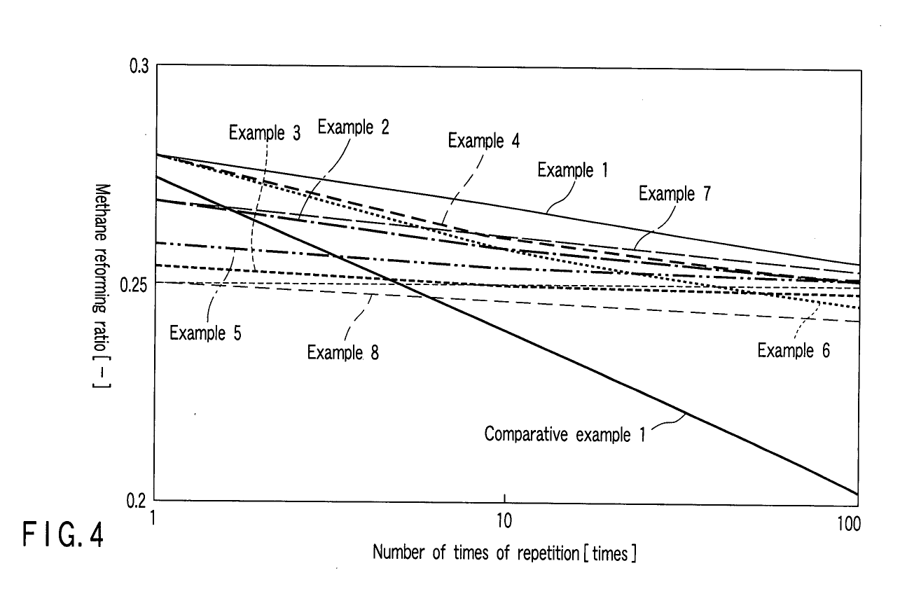

After the steam reforming reaction was performed for 30 min, the reaction was switched to regeneration, and the regeneration was performed for 30 min. This operation was repeated 100 times. Changes in hydrogen production performance during this repetition were obtained on the basis of formula (4) below which indicates the methane reforming ratio after 30 minutes from the start of hydrogen production. FIG. 4 shows the results.
Methane reforming ratio=1−(C₁/C₀) (4)
where C₁ is the number of moles of CH₄ in the finally produced gas exhausted per sec, and C₀ is the number of moles of CH₄ in the source gas supplied per sec.

As shown in FIG. 4, the catalyst-containing reaction accelerators of Examples 1 to 8 had high methane reforming ratios of about 0.25 during the steam reforming reaction even when the steam reforming reaction and the regeneration of the composite absorbent were repeated 100 times.

By contrast, when the catalyst-containing reaction accelerator of Comparative Example 1 was used, the methane reforming ratio during the steam reforming reaction decreased to 0.25 after the steam reforming reaction and the regeneration of the absorbent were repeated 8 times, and decreased to about 0.2 after the reaction and regeneration were repeated 100 times. This is so presumably because in this catalyst-containing reaction accelerator of Comparative Example 1, a molten carbonate was produced when the absorbent absorbed carbon dioxide during the steam reforming reaction, and this molten carbonate moved from the absorbent to the solid catalyst.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

1. A catalyst-containing reaction accelerator used in a steam reforming reaction of hydrocarbon, comprising:
a solid catalyst to accelerate the steam reforming reaction; and
a composite absorbent which is mixed with the solid catalyst, and has a main absorbent which contains a lithium-containing oxide for absorbing and desorbing carbon dioxide by-produced by the steam reforming reaction, and a molten carbonate holding material which does not react with the main absorbent at a temperature at which the main absorbent absorbs and desorbs carbon dioxide.

2. An accelerator according to claim 1, wherein the solid catalyst is selected from the group consisting of a nickel-based catalyst and ruthenium-based catalyst.

3. An accelerator according to claim 1, wherein the lithium-containing oxide is lithium silicate.

4. An accelerator according to claim 1, wherein the molten carbonate holding material is made of particles or fibers of at least one lithium-containing oxide, different from the lithium-containing oxide used in the main absorbent, selected from the group consisting of lithium titanate, lithium aluminate, and lithium zirconate.

5. An accelerator according to claim 1, wherein the main absorbent has a porous structure having a large number of gaps, and the molten carbonate holding material present in at least the gaps of the main absorbent in the form of particles or fibers.

6. An accelerator according to claim 5, wherein the main absorbent consists of particles of the lithium-containing oxide, which have an average particle diameter of not more than 50 μm.

7. An accelerator according to claim 5, wherein the molten carbonate holding material particles have an average particle diameter of 0.1 to 10 μm.

8. An accelerator according to claim 5, wherein the molten carbonate holding material fibers have an average diameter of 0.1 to 5 μm and a length of 1 to 60 μm.

9. An accelerator according to claim 5, wherein the molten carbonate holding material is mixed in the main absorbent within a range of 5 to 30 wt % based on the total amount of the main absorbent and the holding material.

10. An accelerator according to claim 5, wherein the main absorbent has a porosity of not less than 30%.

11. An accelerator according to claim 1 or 5, wherein the solid catalyst and composite absorbent are mixed at a weight ratio of 1:1 to 1:15.

12. A steam reforming method using hydrocarbon, comprising:
preparing a reactor filled with a catalyst-containing reaction accelerator comprising (a) a solid catalyst, and (b) a composite absorbent which is mixed with the solid catalyst, and has a main absorbent which contains a lithium-containing oxide for absorbing and desorbing carbon dioxide by-produced by a steam reforming reaction, and a molten carbonate holding material which does not react with the main absorbent at a temperature at which the main absorbent absorbs and desorbs carbon dioxide; and
supplying hydrocarbon and steam into the reactor at a temperature at which the steam reforming reaction is possible.

13. A method according to claim 12, wherein the hydrocarbon is methane.

14. A method according to claim 12, wherein the main absorbent has a porous structure having a large number of gaps, and the molten carbonate holding material present in at least the gaps of the main absorbent in the form of particles or fibers.

15. A method according to claim 12, wherein when the hydrocarbon is methane, the temperature at which the steam reforming reaction is possible is 500 to 650° C.

16. A method according to claim 12, wherein when the composite absorbent contained in the catalyst-containing reaction accelerator filled in the reactor reacts with carbon dioxide produced in a reaction field and decreases absorptivity thereof, the catalyst-containing reaction accelerator is heated to a temperature higher than the temperature at which the steam reforming reaction is possible, thereby regenerating the composite absorbent.

17. A method according to claim 16, wherein when the main absorbent contained in the composite absorbent contains lithium silicate, the catalyst-containing reaction accelerator is heated to 550 to 800° C. during the regeneration.
